(19) United States
(12) Patent Application Publication
(10) Pub. No.: US 2006/0025128 A1
(43) Pub. Date: Feb. 2, 2006

(54) Soft roaming method used in wireless LAN and station system using the same

(75) Inventor: Cheon-moo Lee, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/188,789

(22) Filed: Jul. 26, 2005

(30) Foreign Application Priority Data
Jul. 26, 2004 (KR) 10-2004-0058267

(51) Int. Cl. H04Q 7/20

(52) U.S. Cl. 455/432.1; 455/422.1

(57) ABSTRACT

A soft roaming method for a wireless local area network (LAN) and a station using the soft roaming method. The soft roaming method includes allowing a station that is associated with a first access point (AP) to obtain AP information by carrying out a channel scanning operation involving continuously switching channels, allowing the station to select a second AP with reference to the AP information when specified conditions are met, and associating the station with the second AP.

### CROSS-REFERENCE TO RELATED APPLICATION

This application claims priority from Korean Patent Application No. 2004-0058267 filed on Jul. 26, 2004 in the Korean Intellectual Property Office, the disclosure of which is incorporated herein by reference.

### BACKGROUND OF THE INVENTION

1. Field of the Invention

The present invention relates to wireless local area network (LAN) communication, and more particularly, to a soft roaming method used in a wireless LAN and a station having a soft roaming function.

2. Description of Related Art

In accordance with recent developments in communication and network technologies, wired networks using coaxial cables or optical cables are being converted to wireless networks using signals of a variety of frequency bands. Accordingly, various movable (i.e., mobile) computing devices (hereinafter referred to as wireless network devices) including wireless network interface modules that serve specific functions by processing various information, and various wireless network techniques that enable such wireless network devices to efficiently communicate with one another have been developed.

Of the various wireless network technologies, the wireless LAN technology described in the IEEE 802.11 standard (ISO/IEC 8802-11: 1999(E) IEEE Std 802.11, 1999 Edition) has been the most widely commercialized technology. The basic communication unit in the IEEE 802.11 network is a basic service set (BSS). In an IEEE 802.11 network, wireless network devices can communicate with one another in a specified zone defined according to propagation characteristics of the signal they use. Specifically, in the IEEE 802.11 network, stations can communicate with one another when in a BSS. There are two BSS types, which will now be described with reference to FIG. 1.

Referring to FIG. 1, a BSS is classified as an independent BSS (shown in part (A)) or an infrastructure BSS (shown in part (B)).

In an independent BSS, stations can directly communicate with one another. For example, station A can communicate with station B, station B can communicate with station C, and station C can communicate with station A or B. Wireless network devices such as laptop computers and personal digital assistants (PDA) are examples of such stations. However, stations are not restricted to such mobile devices. Any type of device that can wirelessly communicate with other devices, for example, a desktop computer, could be defined as a station.

An infrastructure BSS is different from an independent BSS in that it includes an access point (AP). An AP is a device that serves as a wired-to-wireless bridge for connecting an IEEE 802.11 network to a wired network. An AP converts an IEEE 802.11 frame transmitted by a station in the IEEE 802.11 network into a wired network frame and transmits the wired network frame to a station in the wired network. In addition, an AP converts a frame transmitted by the station in the wired network into an IEEE 802.11 frame and transmits the IEEE 802.11 frame to the IEEE 802.11 network. In an infrastructure BSS, stations communicate with one another with the aid of an AP. For example, in order for station A to transmit data to station B, station A transmits a frame containing the data to an AP, and the AP transmits the frame to station B. Likewise, in order for station C to transmit data to station B, station C transmits a frame containing the data to the AP, and the AP transmits the frame to station B.

A wireless network can be established, for example, in a small office or home using a BSS, and a larger wireless network having an arbitrary size can be established by connecting a plurality of BSSs. For this, the IEEE 802.11 standard also defines an extended service set (ESS), an example of which is illustrated in FIG. 2.

Referring to FIG. 2, an ESS includes a plurality of BSSs, i.e., respective first through fifth BSSs BSS1 through BSS5. The coverage of one BSS optionally overlaps the coverage of another BSS. Each of the first through fifth BSSs BSS1 through BSS5 includes an AP. Specifically, the first BSS BSS1 includes a first AP AP1, the second BSS BSS2 includes a second AP AP2, the third BSS BSS3 includes a third AP AP3, the fourth BSS BSS4 includes a fourth AP AP4, and the fifth BSS BSS5 includes a fifth AP AP5. According to the IEEE 802.11 standard, different channels have different frequency bands, and thus, BSSs having different channels do not interfere with one another. In the ESS of FIG. 2, the respective first through fifth BSSs BSS1 through BSS5 are connected to a wired backbone network, which is connected to the Internet via a router. Accordingly, a station in each of the first through fifth BSSs BSS1 through BSS5 can be connected to the Internet via the wired backbone network and the router.

FIG. 3 illustrates the structure of a conventional station that can wirelessly communicate with another conventional station by associating itself with a BSS.

Referring to FIG. 3, the conventional station includes antennas 310, which transmit or receive radio frequency (RF) signals via a wireless medium, a switch 320, which selects a specific RF signal among the received RF signals, an RF and intermediate frequency (IF) converter 330, which converts the received RF signals into IF signals and which converts the IF signals into RF signals to be transmitted, a modem 340, which obtains received baseband digital signals by demodulating received IF signals and which generates IF signals to be transmitted by modulating baseband digital signals, a baseband processor 350, which transmits data to a medium access control (MAC) processor 360 by processing the received baseband digital signals or which generates the baseband digital signals to be transmitted by receiving data from the MAC processor 360, and a MAC processor 360, which controls the accessing of the wireless medium according to the IEEE 802.11 standard.

The conventional station must associate with a BSS in order to communicate with other conventional stations or to communicate with devices in a wired network via an AP. The conventional station performs a channel scanning operation in order to associate with a BSS. As a result of the channel scanning operation, the conventional station can find BSSs and empty channels used by the BSSs. The conventional station associates with the BSS having the AP with the strongest signal (i.e., a signal having the highest signal-to-noise ratio).

For ease of explanation and by way of an example, suppose that, in the ESS of FIG. 2, the first BSS BSS1 uses channel 1, the second BSS BSS2 uses channel 2, the third BSS BSS3 uses channel 3, the fourth BSS BSS4 uses channel 4, and the fifth BSS BSS5 uses channel 5. When the coverage of one BSS overlaps the coverage of another BSS, they must use channels of different frequency bands. On the other hand, when the coverage of one BSS does not overlap the coverage of another BSS, they may use channels of the same frequency band. For example, channel 1 of the first BSS BSS1 may have a different frequency band from channels 2, 3, and 4 of the respective second, third, and fourth BSSs BSS2, BSS3, and BSS4 but may have the same frequency band as channel 5 of the fifth BSS BSS5. When the conventional station of FIG. 3 associates with the first BSS1 through channel scanning, it communicates with the first AP AP1. If the conventional station moves (e.g., a laptop computer is moved), the intensity of the communication signals may diminish. As the conventional station moves away from the AP AP1 and closer to the AP AP2, it may not be able to communicate with the first AP AP1 at some point. In this case, the conventional station performs a channel scanning operation again to find the BSS that currently transmits the highest intensity signal, i.e., the second BSS BSS2 using channel 2, and associates with the second BSS BSS2.

Conventionally, after its communication with an AP is cut off, a station has no option but to associate with the new BSS that transmits the highest intensity signal. In other words, it takes a station a specified amount of time to associate with a new BSS after being disconnected from an old BSS. Such temporary stoppage considerably deteriorates the quality of communication; particularly, Voice over Internet Protocol (VoIP) communication. Therefore, it is necessary to add a soft roaming function to an 802.11 network.

### BREIF SUMMARY

An aspect of the present invention provides a soft roaming method used in a wireless local area network (LAN) and a station having a soft roaming function.

According to an aspect of the present invention, there is provided a soft roaming method in a wireless local area network (LAN), the soft roaming method including allowing a station that is associated with a first access point (AP) to obtain AP information by carrying out a channel scanning operation while continuously switching channels, allowing the station to select a second AP with reference to the AP information when specified conditions are met, and associating the station with the second AP.

According to another aspect of the present invention, there is provided a station that receives a radio frequency (RF) signal transmitted via a wireless medium, obtains a baseband digital signal from the received RF signal, converts the baseband digital signal into an RF signal, and transmits the RF signal via the wireless medium, the station including an RF splitter, which splits an RF signal transmitted via the wireless medium, and a channel scanner, which receives the split RF signal from the RF splitter and scans channels by pass-filtering the split RF signal while periodically switching pass filter frequencies.

According to another aspect of the present invention, there is provided a soft roaming method in a wireless local area network (LAN), the soft roaming method performing an initial channel scanning operation; associating a station with a first of a plurality of APs, the first AP being one that sent a highest intensity signal during the initial channel scanning operation; periodically switching and scanning channels to identify APs; updating an AP information list when the station receives a signal from the first AP in the periodic switching and scanning; determining whether specified conditions for associating with a second AP are met; selecting as the second AP one of a plurality of APs identified in the periodic switching and scanning when the specified conditions are met; and associating the station with the second AR

According to another aspect of the present invention, there is provided a soft roaming method in a wireless local area network (LAN), including: obtaining, via a station associated with a first access point (AP), AP information by channel scanning while continuously switching channels; selecting, via the station, a second AP based on the AP information when specified conditions are met; and associating the station with the second AP.

According to another aspect of the present invention, there is provided a soft roaming method, including: transmitting an association request from a station associated with a first access point (AP) to a second AP; receiving the association request, determining whether to allow association of the station with the second AP and, when association is permitted, transmitting an association response from the second AP to the station; and cancelling the association of the station with the first AP, after receipt of the association response by the station.

According to other aspects of the present invention, there are provided a computer-readable storage media encoded with processing instructions for causing a processor to perform the aforementioned methods.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1, parts (A) and (B), illustrates types of IEEE 802.11 networks;

FIG. 2 is a diagram illustrating an IEEE 802.11 extended service network;

FIG. 3 is a block diagram illustrating a conventional station;

FIG. 4 is a block diagram illustrating a station according to an embodiment of the present invention;

FIG. 5 is a flowchart illustrating a method of selecting an access point (AP) through channel scanning according to an embodiment of the present invention;

FIG. 6 is a sequence diagram illustrating a soft roaming method according to an embodiment of the present invention; and

FIG. 7 is a sequence diagram illustrating a soft roaming method according to another embodiment of the present invention.

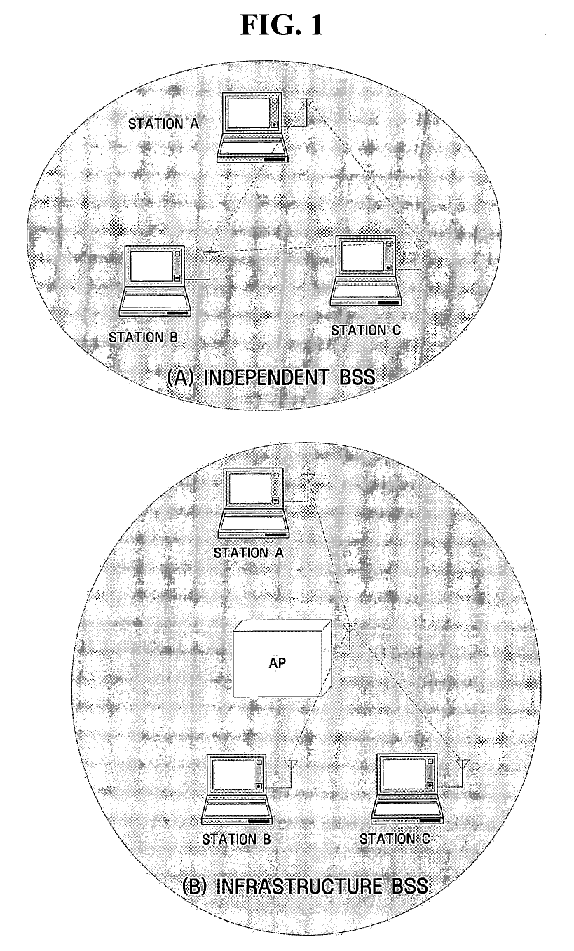

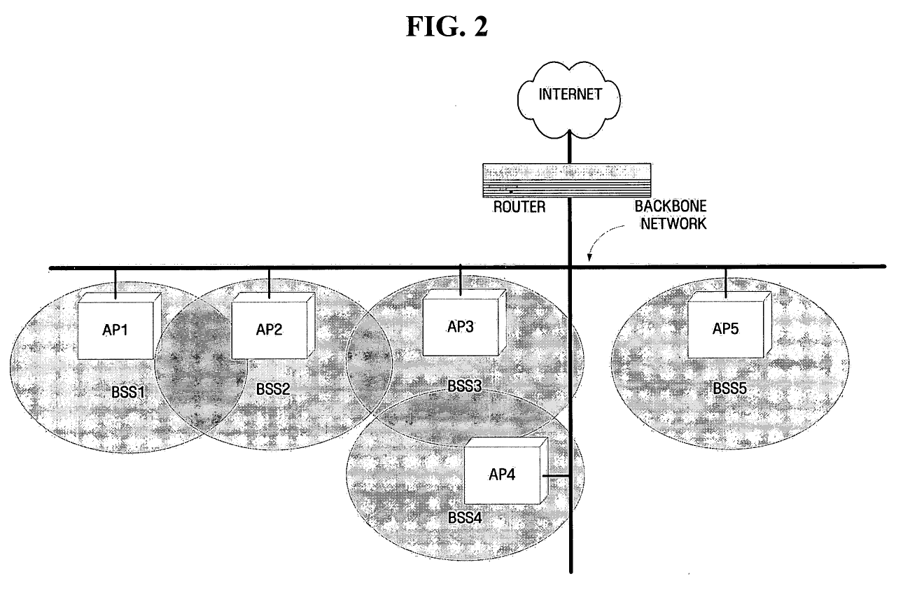

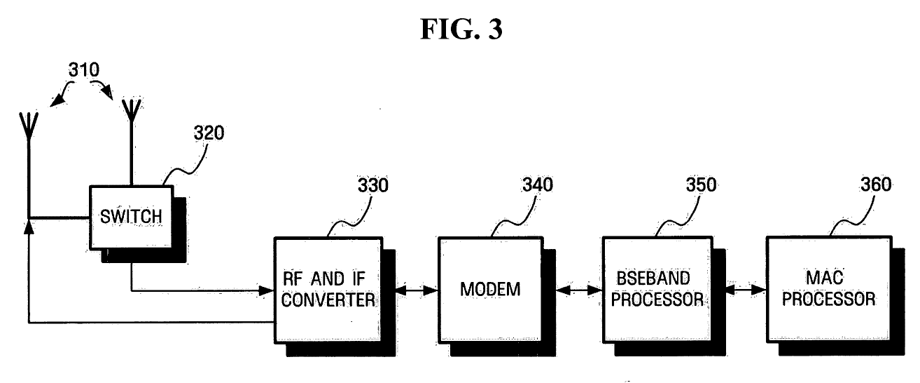

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

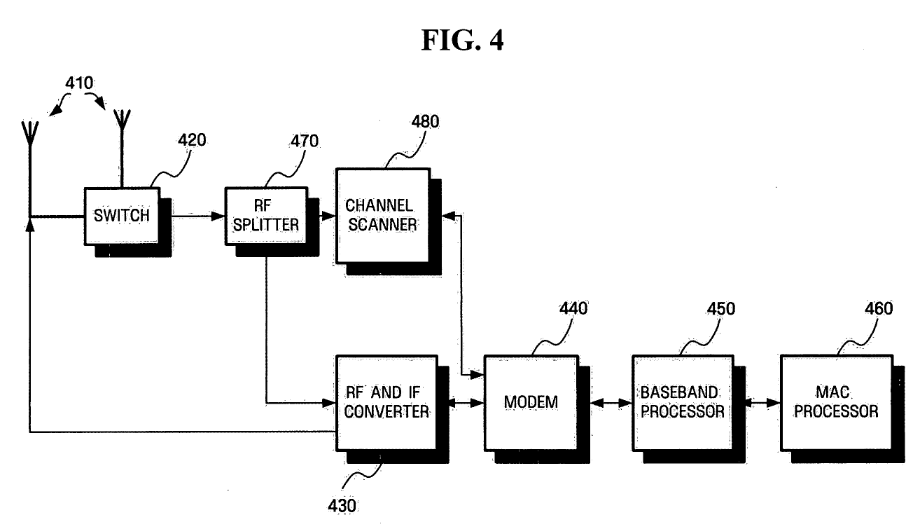

FIG. 4 is a block diagram illustrating a station according to an embodiment of the present invention.

Referring to FIG. 4, the station includes a plurality of antennas 410, a switch 420, a first RF and IF converter 430, a modem 440, a baseband processor 450, and a MAC processor 460.

The antennas 410 transmit RF signals from and receive RF signals for the wireless medium. In the present embodiment, two antennas 410, i.e., a main antenna and an auxiliary antenna, are used in order to prevent fading caused due to multiple paths. An RF signal is transmitted by a transmitter in a plurality of directions so that a plurality of RF signals are received by a receiver. The RF signals received by the receiver may have undergone different amplitude attenuations and different phase changes while taking different paths. The RF signals received by the receiver are combined, thereby obtaining a single RF signal. The intensity of the single RF signal varies differently from the intensity of the original RF signal phenomenon which is called fading. In order to minimize the influence of fading a diversity technique can be applied. In the present embodiment, the station adopts the diversity technique using the two antennas 410 and the switch 420. The switch 420 generally selects an RF signal received via the main antenna. However, if the intensity of the received RF signals is lower than a threshold level, the switch 420 selects an RF signal received via the auxiliary antenna. It is to be understood that the reception of RF signals using the antennas 410 and the switch 420 is merely an example. Thus, RF signals may be received by the station using techniques other than the diversity technique.

An RF signal splitter 470 splits the RF signal selected by the switch 420 into two RF signals and transmits them to the RF and IF converter 430 and a channel scanner 480.

The RF and IF converter 430 includes an RF converter, which converts an IF signal into an RF signal for transmission, and an IF converter, which converts a received RF signal into an IF signal. The RF converter bandpass-filters the received RF signal, mixes the bandpass-filtered RF signal with a sinusoidal carrier wave to produce an IF signal. The IF signal is then transmitted to the modem 440. The IF converter mixes the IF signal with a sinusoidal carrier wave, thereby generating an RF signal, for transmission.

The channel scanner 480 periodically switches and scans channels. The channel scanner 480 may perform a passive scanning operation on channels. For this, the channel scanner 480 periodically changes the frequency to which the RF signal is to be bandpass-filtered. Accordingly, an RF signal received by one of the antennas 410 is bandpass-filtered to the frequency of a channel (hereinafter referred to as a current channel) currently being scanned by the channel scanner 480, and the bandpass-filtered RF signal is mixed with a sinusoidal wave having the same frequency as the current channel, thereby generating an IF signal. The IF signal is transmitted to the modem 440 and then demodulated. The station obtains information on the current channel (or an AP) from the demodulated IF signal. Alternatively, the channel scanner 480 may actively scan channels. In this case, the channel scanner 480 receives a request for a probe request signal from the modem 440, generates a probe request signal having the same frequency band as the current channel, and transmits the generated probe request signal to the antennas 410. Thereafter, the probe request signal is transmitted by the antennas 410 is. If the station receives no probe response signal, it considers the current channel is empty. However, if the station receives a probe response signal, it recognizes that a BSS using the current channel exists. The probe response signal is received by the antennas 410, converted into an IF probe response signal by the channel scanner 480, and is then transmitted to the modem 440.

The modem 440 receives an IF signal from the RF and IF converter 430 or from the channel scanner 480 and demodulates the received IF signal, thereby generating a digital signal. Thereafter, the modem 440 transmits the digital signal to the baseband processor 450. In addition, the modem 440 receives a digital signal from the baseband processor 450 and modulates the received digital signal, thereby generating an IF signal. Thereafter, the modem 440 transmits the IF signal to the RF and IF converter 430. When the station scans channels actively, rather than passively, the modem 440 modulates a baseband probe request signal, which is used in the scanning of channels for soft roaming, into an IF probe request signal and transmits the IF probe request signal to the channel scanner 480.

The baseband processor 450 extracts a Physical Layer Convergence Procedure (PLCP) service data unit (PSDU) from the digital signal received from the modem 440 and transmits the extracted PSDU to the MAC processor 460. In addition, the baseband processor 450 receives a PSDU from the MAC processor 460, scrambles the received PSDU, and attaches an appropriate PLCP header to the scrambled PSDU, thereby generating a PLCP protocol data unit (PPDU). The PPDU is transmitted to the modem 440.

The MAC processor 460 extracts a MAC header from a PSDU (i.e., a MAC frame) input thereto according to the 802.11 MAC standard and recognizes the type, sender, and receiver. The MAC processor 460 transmits the MAC service data unit (MSDU) contained in the received MAC frame to a level above the station. If the received MAC frame is not a broadcasted frame intended for the station of FIG. 4, the MAC processor 460 abandons the received MAC frame. In addition, the MAC processor 460 receives an MSDU from the level above the station, attaches an appropriate MAC header and a frame check sequence (FCS), which is used for detecting errors that may occur in the process of transmitting a MSDU, to the received MSDU and transmits the resulting MSDU to the baseband processor 450.

As described above, the station of FIG. 4 converts a baseband digital signal to an IF signal and then converts the IF signal into an RF signal for transmission, or it converts a received RF signal into an IF signal and then converts the IF signal into a baseband digital signal. However, the station of FIG. 4 may directly convert an RF signal into a baseband digital signal without the need to convert the RF signal into an IF signal, in which case, the modem 440 directly modulates a baseband digital signal into an RF signal or directly demodulates a received RF signal into a baseband digital signal.

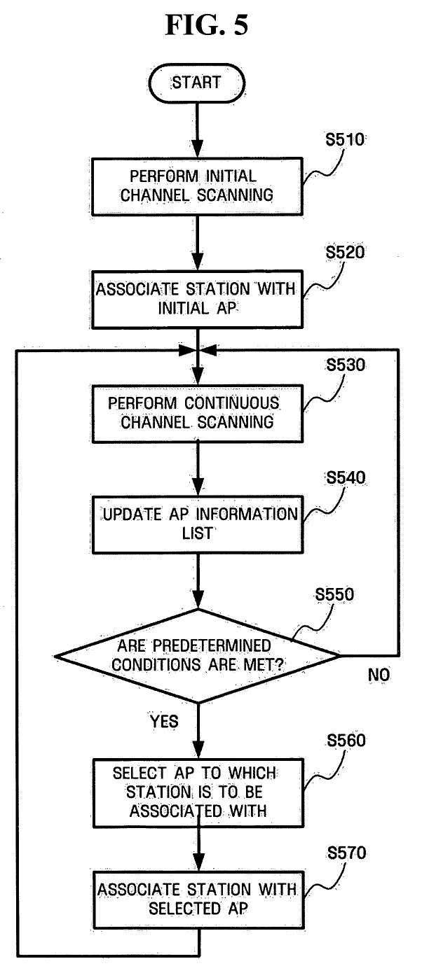

FIG. 5 is a flowchart illustrating a method of selecting an AP through channel scanning according to an embodiment of the present invention.

Referring to FIG. 5, in operation S510, a station carries out an initial channel scanning operation according to an active channel scanning method or a passive channel scanning method.

In operation S520, as a result of the initial channel scanning operation, the station is associated with the AP that sent the highest intensity signal. Specifically, the station issues an association request to the AP, and the AP authenticates the station and transmits an association response message to the station. When associated with the AP, the station becomes a member of a specified BSS and can transmit data to and receive data from other stations in the specified BSS. In addition, the station can transmit data to a device in a wired network through the AP (hereinafter referred to as a current AP) that it is currently associated with, or it can receive data transmitted from the device in the wired network from the current AP.

In operation S530, once the station is associated with the current AP, the station periodically switches and scans channels. For example, supposing that the station can use channels 1 through 10 and is associated with an AP using channel 3, the station sequentially scans channels 1, 2, 4, 5, 6, 7, 8, 9, and 10 using either an active or passive channel scanning method. The passive channel scanning method is more effective than the active channel scanning method in terms of energy consumption, and thus, the station may scan channels 1, 2, 4, 5, 6, 7, 8, 9, and 10 using the passive channel scanning method. When carrying out the passive channel scanning method, the station listens to a channel for a specified channel time. The channel time is longer than probe delay, which is the amount of time delayed before transmitting a probe frame in the middle of actively scanning channels.

Thereafter, the station scans a subsequent channel. Here, the station may scan channels 1 though 10 (excluding channel 3) in a different order. For example, the station may sequentially scan channels 10, 9, 8, 7, 6, 5, 4, 2, and 1.

In operation S540, if the station receives a signal transmitted by the current AP as a result of the channel scanning operation, it updates an AP information list. The AP information list includes information on a plurality of APs of the channels scanned by the station, and the station can select one of these APs and associate with this AP.

The AP information list may include information on the intensities of the signals received from the APs as a result of the channel scanning operation. The intensities of the received signals may be measured based on received signal strength indication (RSSI) or based on signal to noise ratios or bit error ratios.

Alternatively, the AP information list may include information on the number of member stations associated with each of the APs of the scanned channels. In general, if the number of member stations included in a BSS increases, each member station is likely to have far less opportunities to transmit data even though it can successfully associate themselves with the BSS. Therefore, in the present embodiment, the station does not determine whether a specified AP is its target AP solely based on the intensity of a signal transmitted by the specified AP, but it identifies a plurality of APs that transmit signals whose intensities are higher than a specified level and then it decides to associate itself with one of the APs with the smallest number of member stations associated therewith. For this, the AP information list may include information on the number of member stations of each of the APs of the scanned channels. In the present embodiment, each of the APs broadcasts a frame containing information on the number of member stations associated with its BSS, and the station receives this frame and recognizes how many member stations are associated with the AP. Alternatively, in the present embodiment, the station may issue a request to the AP of the current channel for transmission of a frame containing the number of member stations associated with the AP and it recognize how many member stations are associated with the AP of the current channel based on the received frame.

In still another contemplated alternative, the AP information list may also include total available bandwidth information of BSSs of the APs of the scanned channels and bandwidth information of data that has been recently transmitted from the APs. Even though the number of member stations belonging to a specified BSS is large, each member station may have enough opportunities to transmit data after associating themselves with the specified BSS if there are not many member stations that actually attempt to transmit data. The station may passively receive the bandwidth information of the data that has been recently transmitted from the APs or it may actively issue a request for the bandwidth information.

In operation S550, the station determines whether specified conditions for associating with an AP other than the current AP are met. The specified conditions may be met when the channel scanning results obtained in operation S530 show that there exist APs that can provide a better channel environment than the current AP in terms of sending signals having a higher intensity or providing more opportunities to transmit data. Alternatively, the specified conditions may be met when a specified value indicating a channel environment provided by the current AP is smaller than a specified reference value, in which case, even though the current AP is not an optimum AP for the station, the station can still be guaranteed a specified number of opportunities to communicate, and the number of times that the station has to associate itself to an optimum AP through roaming can be reduced.

After operation S550, if the specified conditions are not met, the method returns to operation S530 and the station continuously carries out a channel scanning operation via the current AP. If the specified conditions are met, the method proceeds to operation S560 and the station selects one of a plurality of APs that were discovered in the channel scanning operation. For example, the station may select one of the discovered APs that provides an optimum channel environment for the station with reference to AP information included in the AP information list. In the present embodiment, a channel environment provided by an AP may be interpreted as the intensity of signals transmitted to the station by the AP or the number of opportunities for the station to transmit data. If a channel environment provided by an AP is interpreted as the number of opportunities for the station to transmit data, then the number of opportunities to transmit data can be given to the station by the AP based on the number of member stations associated with the AP or the data transmission bandwidth of the BSS to which the AP belongs.

In operation S570, the station associates itself with the AP selected in operation S560 by issuing an association request to the selected AP, and the method returns to operation S530 so that the station carries out a channel scan operation again.

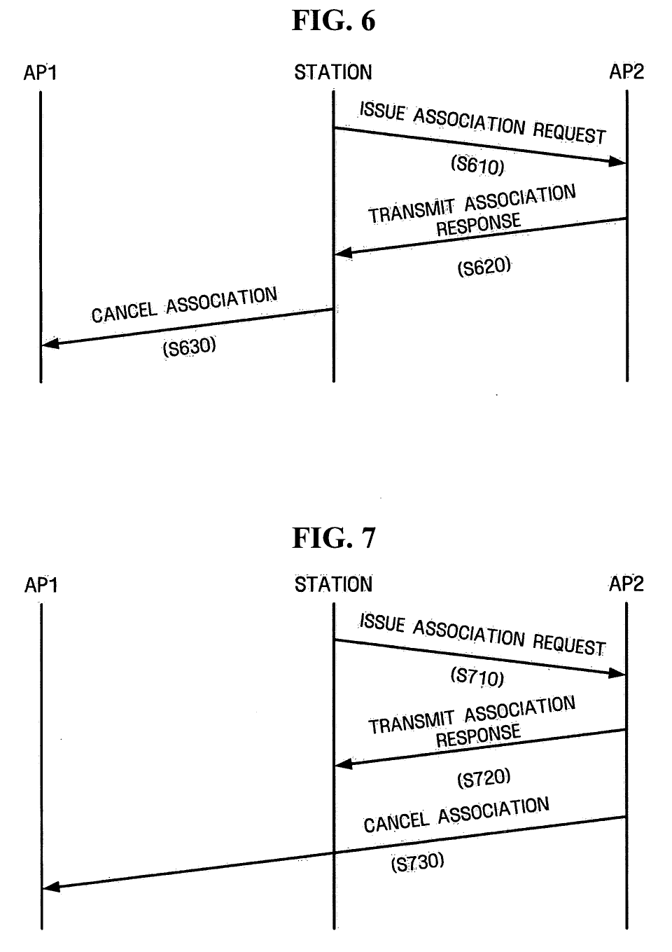

A soft roaming method according to an embodiment of the present invention that associates a station that is currently associated with a first AP AP1 with a second AP AP2 without disconnecting the station from the first AP will now be described in detail with reference to FIGS. 6 and 7.

Referring first to FIG. 6, in operation S610, a station issues an association request to the second AP AP2 by using, for example, an IEEE 802.11 association request frame or an IEEE 802.11 re-association request frame. When using an IEEE 802.11 re-association request frame, the station may not need to be authenticated by the second AP AP2. The second AP AP2 receives the association request from the station and decides whether to allow the station to be associated therewith.

In operation S620, if the second AP AP2 allows the station to be associated therewith, it transmits an association response to the station.

In operation S630, the station receives the association response from the second AP AP2 and then notifies the first AP AP1 that it will cancel its association with the first AP AP1.

Referring to FIG. 7, operations S710 and S720 are the same as operations S610 and S620, respectively, of FIG. 6. However, in operation S730, unlike in operation S630 of FIG. 6, the second AP AP2 notifies the first AP AP1 that the station will cancel its association with the first AP AP1. The station may decide to cancel its association with the first AP AP1 and to associate itself with the second AP because of a deteriorating channel environment provided by the first AP AP1, in which case, a message notifying that the station will cancel its association with the first AP AP1 may not be successfully transmitted to the first AP AP1. In the present embodiment, however, the second AP AP2 transmits the message to the first AP AP1 via a backbone network. Thus, the message is more likely to be received by the first AP AP1 when transmitted by the second AP AP2 than when transmitted by the station, as illustrated in FIG. 6.

The above-described embodiments of the present invention can be implemented as computer-readable code stored on a computer-readable storage medium. Examples of computer-readable storage media include various kinds of recording devices for storing data to be read by a computer system, such as ROM, RAM, CD-ROM, magnetic tape, floppy disk, and optical data storage device. A medium implemented in a form of a carrier wave (e.g., a transmission over Internet) is another example of the computer-readable storage medium. Further, the computer-readable storage medium can be distributed in a computer system connected over a network, and the computer-readable code is recorded and implemented in a distributed manner.

According to the above-described embodiments of the present invention, a station can obtain information on an access point (AP) that provides an optimum channel environment through a continuous channel scanning operation and thus can associate itself with an AP that provides a better channel environment than an AP that it is currently associated with without being disconnected.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A soft roaming method in a wireless local area network (LAN), the soft roaming method comprising:
allowing a station that is associated with a first access point (AP) to obtain AP information by carrying out a channel scanning operation while continuously switching channels;
allowing the station to select a second AP with reference to the AP information when specified conditions are met; and
associating the station with the second AP.

2. The soft roaming method of claim 1, wherein the channel scanning operation is a passive channel scanning operation.

3. The soft roaming method of claim 1, wherein the second AP is an AP that provides an optimum channel environment with reference to the AP information discovered through the channel scanning operation.

4. The soft roaming method of claim 3, wherein the specified conditions are met when a specified value indicating a channel environment provided by the first AP is not higher than a reference value.

5. The soft roaming method of claim 1, wherein the AP information is the intensity of signals transmitted to the station by an AP of a channel currently being scanned by the station in the channel scanning operation.

6. The soft roaming method of claim 1, wherein the AP information is the number of member stations associated with an AP of a channel currently being scanned by the station in the channel scanning operation.

7. The soft roaming method of claim 1, wherein the associating of the station with the second AP includes:
allowing the station to issue an association request to the second AP; and
allowing the station to receive an association response from the second AP.

8. A station that receives a radio frequency (RF) signal transmitted via a wireless medium, obtains a baseband digital signal from the received RF signal, converts the baseband digital signal into an RF signal, and transmits the RF signal via the wireless medium, the station comprising:
an RF splitter that splits an RF signal transmitted via the wireless medium; and
a channel scanner that receives the split RF signal from the RF splitter and scans channels by bandpass-filtering the split RF signal while periodically switching frequencies.

9. The station of claim 8, wherein the channel scanner is a passive channel scanner.

10. A computer-readable storage medium encoded with processing instructions for causing a processor to perform a soft roaming method in a wireless local area network (LAN), the soft roaming method comprising:
allowing a station that is associated with a first access point (AP) to obtain AP information by carrying out a channel scanning operation while continuously switching channels;
allowing the station to select a second AP with reference to the AP information when specified conditions are met; and
associating the station with the second AP.

11. A soft roaming method in a wireless local area network (LAN), the soft roaming method comprising:
performing an initial channel scanning operation;
associating a station with a first AP of a plurality of APs, the first AP being one that sent a highest intensity signal during the initial channel scanning operation;
periodically switching and scanning channels to identify APs;
updating an AP information list when the station receives a signal from the first AP in the periodic switching and scanning;
determining whether specified conditions for associating with a second AP are met;
selecting as the second AP one of a plurality of APs identified in the periodic switching and scanning when the specified conditions are met; and
associating the station with the second AP.

12. The method of claim 11, wherein the AP information list includes information on the APs of channels scanned by the station, information on the intensities of signals received from the APs, information on a number of member stations associated with each of the APs of the scanned channels; or a total available bandwidth information of basic service sets (BSSs) of the APs of the scanned channels and bandwidth information of data that has been recently transmitted from the APs.

13. The method of claim 12, wherein the intensities of the received signals are measured based on a received signal strength indication (RSSI), signal to noise ratios, or bit error ratios.

14. The method of claim 11, wherein the specified conditions are met when there are APs that are capable of sending signals having a higher intensity or providing more opportunities to transmit data than the first AP or when a specified value indicating a channel environment provided by the first AP is less than a specified reference value.

15. The method of claim 11, wherein, in the selecting, the second AP is selected based on AP information included in the AP information list.

16. A soft roaming method in a wireless local area network (LAN), comprising:
obtaining, via a station associated with a first access point (AP), AP information by channel scanning while continuously switching channels;
selecting, via the station, a second AP based on the AP information when specified conditions are met; and
associating the station with the second AP.

17. A soft roaming method, comprising:
transmitting an association request from a station associated with a first access point (AP) to a second AP;
receiving the association request, determining whether to allow association of the station with the second AP and, when association is permitted, transmitting an association response from the second AP to the station; and
cancelling the association of the station with the first AP, after receipt of the association response by the station.

18. The method of claim 17, wherein, in the cancelling, the first AP is notified by the station.

19. The method of claim 17, wherein, in the cancelling, the first AP is notified by the second AP.

20. A computer-readable storage medium encoded with processing instructions for causing a processor to perform a soft roaming method in a wireless local area network (LAN), the soft roaming method comprising:
performing an initial channel scanning operation;
associating a station with a first AP of a plurality of APs, the first AP being one that sent a highest intensity signal during the initial channel scanning operation;
periodically switching and scanning channels to identify APs;
updating an AP information list when the station receives a signal from the first AP in the periodic switching and scanning;
determining whether specified conditions for associating with a second AP are met;
selecting as the second AP one of a plurality of APs identified in the periodic switching and scanning when the specified conditions are met; and
associating the station with the second AP.

21. A computer-readable storage medium encoded with processing instructions for causing a processor to perform a soft roaming method in a wireless local area network (LAN), the soft roaming method comprising:
obtaining, via a station associated with a first access point (AP), AP information by channel scanning while continuously switching channels;
selecting, via the station, a second AP based on the AP information when specified conditions are met; and
associating the station with the second AP.

22. A computer-readable storage medium encoded with processing instructions for causing a processor to perform a soft roaming method in a wireless local area network (LAN), the soft roaming method comprising:
transmitting an association request from a station associated with a first access point (AP) to a second AP;
receiving the association request, determining whether to allow association of the station with the second AP and, when association is permitted, transmitting an association response from the second AP to the station; and
cancelling the association of the station with the first AP, after receipt of the association response by the station.
